(19) United States
(12) Patent Application Publication
(10) Pub. No.: US 2009/0176382 A1
(43) Pub. Date: Jul. 9, 2009

(54) Electric Coupler for Camping Trailer

(76) Inventor: Keng-Hsing Chen, Changhua City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/970,893

(22) Filed: Jan. 8, 2008

(51) Int. Cl. H01R 33/00

(52) U.S. Cl. 439/35

(57) ABSTRACT

An electric coupler for a camping trailer includes a first connector, and a second connector mounted on the first connector. The first connector has a mounting groove, and the second connector has a mounting block inserted into the mounting groove of the first connector. Thus, the first connector is connected to a first electric power system, and the second connector is connected to a second electric power system, so that the trailer is connected to the first electric power system and the second electric power system respectively for use with a user. In addition, the mounting block of the second connector is inserted into the mounting groove of the first connector to combine the second connector and the first connector together so that the electric coupler is assembled easily and quickly.

### BACKGROUND OF THE INVENTION

1. Field of the Invention

The present invention relates to a coupler and, more particularly, to an electric coupler for a camping trailer.

2. Description of the Related Art

A conventional electric coupler 10 in accordance with the prior art shown in FIG. 4 is connected to a camping trailer by electric power lines and is connected to a power supply to transmit an electric power from the power supply to the camping trailer for use with a user. The camping trailer is provided with two different electric power systems, including an alternating current power system and a direct current power system, respectively which are operated individually. However, when the electric coupler 10 is connected to the power supply in an erroneous manner, the electric power systems of the camping trailer will be broken or damaged, thereby causing danger to the user.

### BRIEF SUMMARY OF THE INVENTION

In accordance with the present invention, there is provided an electric coupler for a camping trailer, comprising, a first connector, and a second connector detachably mounted on the first connector. The first connector has a side provided with a mounting groove, and the second connector has a side provided with a mounting block inserted into the mounting groove of the first connector to attach the second connector to the first connector.

Preferably, the mounting groove of the first connector is defined by two protruding limit plates spaced from each other.

Preferably, each of the two limit plates of the first connector has a substantially L-shaped profile.

Preferably, the mounting block of the second connector has a substantially T-shaped profile.

Preferably, the mounting block of the second connector has two opposite sides each provided with two protruding limit piece abutting and limited by a respective one of the two limit plates of the first connector.

Preferably, the mounting groove of the first connector has a face provided with an elongate locking slot, and the mounting block of the second connector has a face provided with an elongate locking rib inserted into and locked in the locking slot of the mounting groove of the first connector to lock the mounting block of the second connector in the mounting groove of the first connector.

Preferably, the locking rib of the mounting block of the second connector has a flexible feature so that the locking rib of the mounting block of the second connector is compressible to enter the mounting groove of the first connector when the mounting block of the second connector is inserted into the mounting groove of the first connector.

The primary objective of the present invention is to provide an electric coupler for a camping trailer, wherein the first connector of the electric coupler is connected to a first electric power system, and the second connector of the electric coupler is connected to a second electric power system, so that the trailer is connected to the first electric power system and the second electric power system respectively for use with a user.

Another objective of the present invention is to provide an electric coupler for a camping trailer, wherein the mounting block of the second connector is inserted into the mounting groove of the first connector to combine the second connector and the first connector together so that the electric coupler is assembled easily and quickly.

A further objective of the present invention is to provide an electric coupler for a camping trailer, wherein the locking rib of the mounting block of the second connector is inserted into and locked in the locking slot of the mounting groove of the first connector to lock the mounting block of the second connector in the mounting groove of the first connector so as to combine the second connector and the first connector together exactly and closely.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of an electric coupler for a camping trailer in accordance with the preferred embodiment of the present invention.

FIG. 2 is an exploded perspective view of the electric coupler for a camping trailer as shown in FIG. 1.

FIG. 3 is a perspective view showing the electric coupler being mounted on a camping trailer.

FIG. 4 is a perspective view of a conventional electric coupler for a camping trailer in accordance with the prior art.

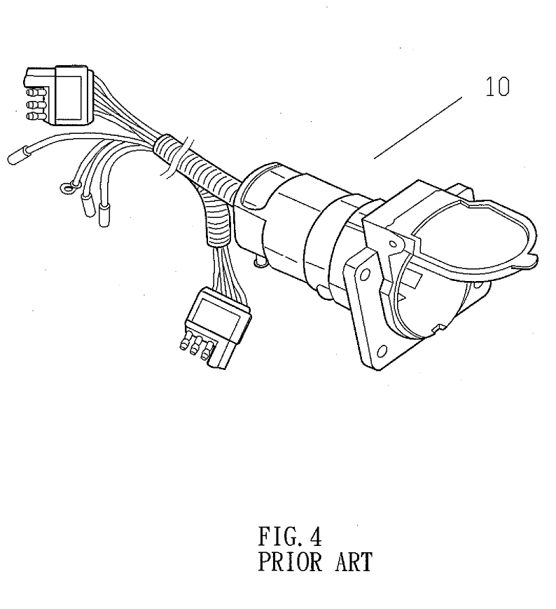

### DETAILED DESCRIPTION OF THE INVENTION

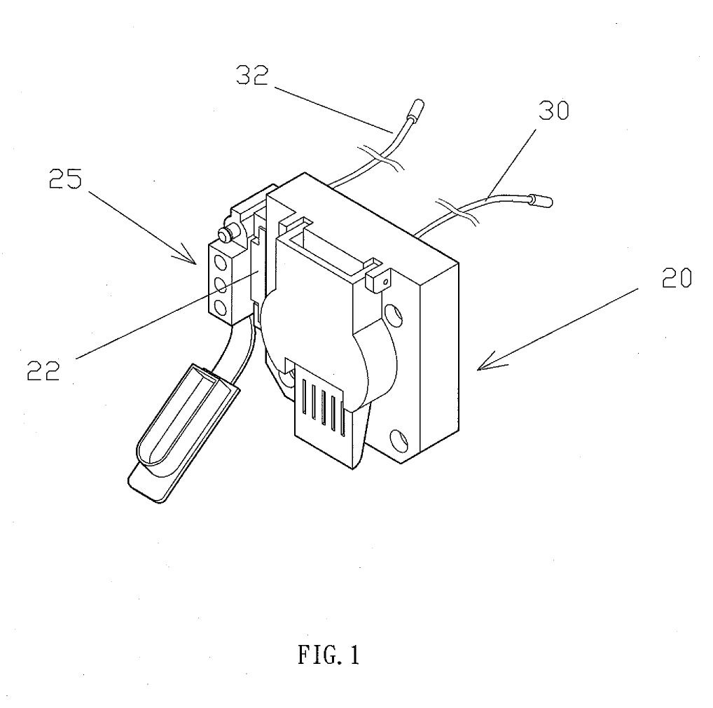

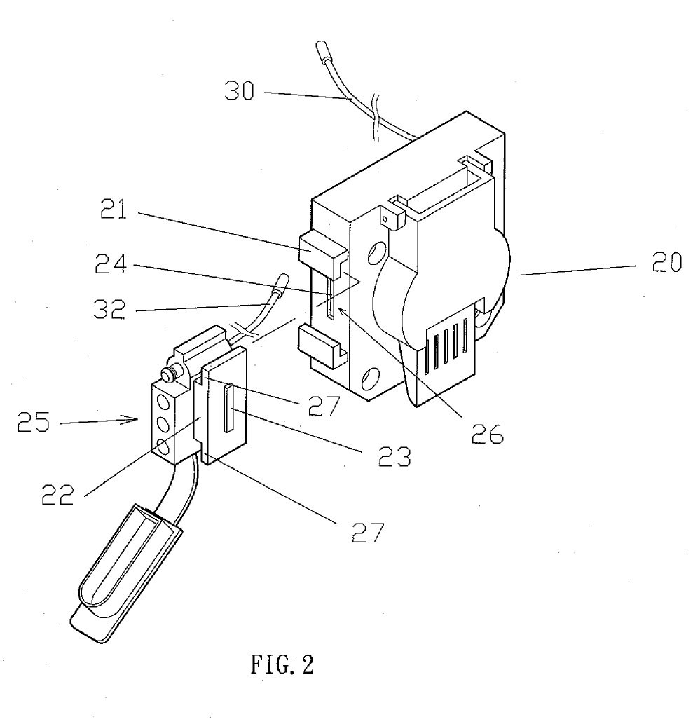

Referring to the drawings and initially to FIGS. 1 and 2, an electric coupler for a camping trailer in accordance with the preferred embodiment of the present invention comprises a first connector 20, a first power line 30 connected to the first connector 20, a second connector 25 detachably mounted on the first connector 20, and a second power line 32 connected to the second connector 25.

The first connector 20 has a side provided with a mounting groove 26. The mounting groove 26 of the first connector 20 is defined by two protruding limit plates 21 spaced from each other. Each of the two limit plates 21 of the first connector 20 has a substantially L-shaped profile. The mounting groove 26 of the first connector 20 has a face provided with an elongate locking slot 24.

The second connector 25 has a side provided with a mounting block 22 inserted into the mounting groove 26 of the first connector 20 to attach the second connector 25 to the first connector 20. The mounting block 22 of the second connector 25 has a substantially T-shaped profile and has two opposite sides each provided with two protruding limit piece 27 abutting and limited by a respective one of the two limit plates 21 of the first connector 20. The mounting block 22 of the second connector 25 has a face provided with an elongate locking rib 23 inserted into and locked in the locking slot 24 of the mounting groove 26 of the first connector 20 to lock the mounting block 22 of the second connector 25 in the mounting groove 26 of the first connector 20. The locking rib 23 of the mounting block 22 of the second connector 25 has a flexible feature so that the locking rib 23 of the mounting block 22 of the second connector 25 is compressible to enter the mounting groove 26 of the first connector 20 when the mounting block 22 of the second connector 25 is inserted into the mounting groove 26 of the first connector 20.

In assembly, the mounting block 22 of the second connector 25 is inserted into the mounting groove 26 of the first connector 20 until the locking rib 23 of the mounting block 22 of the second connector 25 aligns with the locking slot 24 of the mounting groove 26 of the first connector 20 so that the locking rib 23 of the mounting block 22 of the second connector 25 is inserted into and locked in the locking slot 24 of the mounting groove 26 of the first connector 20 to lock the mounting block 22 of the second connector 25 in the mounting groove 26 of the first connector 20 so as to combine the second connector 25 and the first connector 20 together.

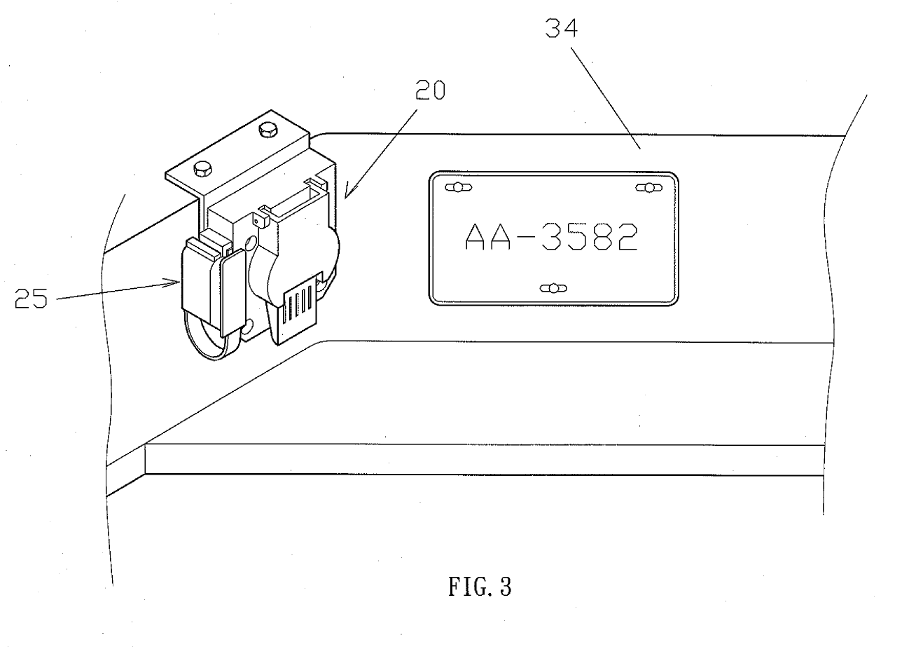

In practice, referring to FIG. 3 with reference to FIGS. 1 and 2, the first connector 20 and the second connector 25 are combined together to form the electric coupler, and the electric coupler is mounted on a trailer 34. At this time, the first connector 20 of the electric coupler is connected to a first electric power system, such as an alternating current power system, and the second connector 25 of the electric coupler is connected to a second electric power system, such as a direct current power system. In addition, the first power line 30 and the second power line 32 of the electric coupler are connected to the trailer 34. Thus, the trailer 34 is connected to the first electric power system and the second electric power system respectively for use with a user.

Accordingly, the first connector 20 of the electric coupler is connected to a first electric power system, and the second connector 25 of the electric coupler is connected to a second electric power system, so that the trailer 34 is connected to the first electric power system and the second electric power system respectively for use with a user. In addition, the mounting block 22 of the second connector 25 is inserted into the mounting groove 26 of the first connector 20 to combine the second connector 25 and the first connector 20 together so that the electric coupler is assembled easily and quickly. Further, the locking rib 23 of the mounting block 22 of the second connector 25 is inserted into and locked in the locking slot 24 of the mounting groove 26 of the first connector 20 to lock the mounting block 22 of the second connector 25 in the mounting groove 26 of the first connector 20 so as to combine the second connector 25 and the first connector 20 together exactly and closely.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An electric coupler for a camping trailer, comprising:
a first connector;
a second connector detachably mounted on the first connector;
wherein the first connector has a side provided with a mounting groove;
wherein the second connector has a side provided with a mounting block inserted into the mounting groove of the first connector to attach the second connector to the first connector.

2. The electric coupler for a camping trailer in accordance with claim 1, wherein the mounting groove of the first connector is defined by two protruding limit plates spaced from each other.

3. The electric coupler for a camping trailer in accordance with claim 2, wherein each of the two limit plates of the first connector has a substantially L-shaped profile.

4. The electric coupler for a camping trailer in accordance with claim 3, wherein the mounting block of the second connector has a substantially T-shaped profile.

5. The electric coupler for a camping trailer in accordance with claim 2, wherein the mounting block of the second connector has two opposite sides each provided with two protruding limit piece abutting and limited by a respective one of the two limit plates of the first connector.

6. The electric coupler for a camping trailer in accordance with claim 2, wherein
the mounting groove of the first connector has a face provided with an elongate locking slot;
the mounting block of the second connector has a face provided with an elongate locking rib inserted into and locked in the locking slot of the mounting groove of the first connector to lock the mounting block of the second connector in the mounting groove of the first connector.

7. The electric coupler for a camping trailer in accordance with claim 6, wherein the locking rib of the mounting block of the second connector has a flexible feature so that the locking rib of the mounting block of the second connector is compressible to enter the mounting groove of the first connector when the mounting block of the second connector is inserted into the mounting groove of the first connector.

8. The electric coupler for a camping trailer in accordance with claim 1, further comprising:
a first power line connected to the first connector;
a second power line connected to the second connector.
